(19) United States
(12) Patent Application Publication
(10) Pub. No.: US 2023/0062836 A1
(43) Pub. Date: Mar. 2, 2023

(54) REMEDIATION PROCESSES AND SYSTEMS

(71) Applicant: ASRC Energy Services, LLC, Anchorage, AK (US)

(72) Inventors: Liam Thomas Fairburn ZSOLT, Anchorage, AK (US); Simon Mattias FLANDER, Anchorage, AK (US); Lindsay PANIGEO, Anchorage, AK (US); Rysen SHIRZADI, Anchorage, AK (US); Paul W. MCGUIRE, Anchorage, AK (US)

(21) Appl. No.: 17/891,892

(22) Filed: Aug. 19, 2022

Related U.S. Application Data
(63) Continuation of application No. PCT/US2021/019134, filed on Feb. 22, 2021.
(60) Provisional application No. 62/979,885, filed on Feb. 21, 2020.

(51) Int. Cl. B09B 3/40; F27D 11/06

(52) U.S. Cl. CPC B09B 3/40; F27D 11/06

(57) ABSTRACT

This disclosure relates to remediation processes and systems. Disclosed herein are processes and systems for remediation of material contaminated with one or more per- and polyfluoroalkyl substance (PFAS) compounds.

### CROSS-REFERENCE TO RELATED APPLICATIONS

This application is a continuation of international patent application no. PCT/US2021/019134 filed Feb. 22, 2021 and entitled “REMEDIATION PROCESSES AND SYSTEMS” and claims the benefit of U.S. provisional patent application No. 62/979,885 filed Feb. 21, 2020 and entitled “REMEDIATION PROCESSES AND SYSTEMS,” the entire contents of each of which are hereby incorporated herein by reference in their entirety.

### COPYRIGHT NOTICE

©2022 ASRC Energy Services. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This disclosure relates generally to environmental technologies and in particular to remediation processes and systems.

### BACKGROUND

Per- and polyfluoroalkyl substance (PFAS) compounds are a large group of compounds (>6,000) that have an alkyl chain. The perfluoroalkyl compounds have fluorine (F) atoms bonded to all of the carbon (C) atoms in the alkyl chain (also referred to as the backbone). The polyfluoroalkyl compounds have some hydrogen (H) atoms in addition to F atoms bonded to the C atoms of the alkyl chain. PFAS compounds have unique surfactant properties. The alkyl tails make these substances both hydrophobic (water-repelling) and oleophobic/lipophobic (oil/fat-repelling).

Because of these properties, PFAS compounds have been used extensively in surface coating and protectant formulations. Major applications have included protectants that enhance water, grease, and soil repellency for paper and cardboard packaging products, carpets, leather products, and textiles. The compounds also have been widely used in industrial surfactants, emulsifiers, wetting agents, additives, and coatings. PFAS compounds have been used in fire-fighting foams because they are effective in extinguishing hydrocarbon-fueled fires. They are also used as processing aids in the manufacture of fluoropolymers, such as nonstick coatings on cookware, membranes for clothing that are both waterproof and breathable, electrical wire casing, fire- and chemical-resistant tubing, and plumbing thread seal tape.

The fluorine-carbon bonds in PFAS compounds are very stable and give these substances high thermal and chemical stability. PFAS compounds are persistent in the environment. Many PFAS compounds are found worldwide in the environment, wildlife, and humans. Bioaccumulation of PFAS compounds in humans is a concern.

A need exists for alternative remediation processes and systems for removing PFAS compounds from contaminated materials.

### BRIEF DESCRIPTION OF THE DRAWINGS

The embodiments disclosed herein will become more fully apparent from the following description and appended claims, taken in conjunction with the accompanying drawings. The drawings depict primarily generalized embodiments, which embodiments will be described with additional specificity and detail in connection with the drawings in which:

FIG. 1 illustrates an exemplary embodiment of a system for removing a PFAS compound from contaminated material.

FIG. 2 illustrates an exemplary variation of the embodiment illustrated in FIG. 1.

FIG. 3 illustrates an exemplary variation of the embodiment illustrated in FIG. 1.

FIG. 4 illustrates an exemplary variation of the embodiment illustrated in FIG. 1.

FIG. 5 illustrates an exemplary variation of the embodiment illustrated in FIG. 1.

FIG. 6 illustrates an exemplary variation of the embodiment illustrated in FIG. 1.

FIG. 7 illustrates an exemplary variation of the embodiment illustrated in FIG. 1.

FIG. 8 illustrates another exemplary embodiment of a system for removing a PFAS compound from contaminated material.

FIG. 9 illustrates an exemplary variation of the embodiment illustrated in FIG. 8.

FIG. 10 is a cross-section diagram illustrating an exemplary embodiment of a system for removing a PFAS compound from contaminated material.

FIG. 11 is a cross-section diagram of a scale model of an exemplary rotatable barrel illustrating advancing flights and lifting flights in accordance with the present disclosure.

FIG. 12 is a graph showing the concentration of PFAS compounds in untreated soil samples collected from four collection sites.

FIG. 13 is a graph showing the concentration of six regulated PFAS analytes based on treatment degree-minutes above 500° F. in soil samples treated in accordance with an embodiment of the present disclosure.

FIG. 14 is a graph showing the concentration of the six regulated PFAS analytes from FIG. 13 based solely on treatment temperature.

FIG. 15 is a graph showing the concentration of the six regulated PFAS analytes based solely on treatment time.

FIG. 16 is a graph showing temperature signatures of a desorption treatment in accordance with an embodiment of the present disclosure.

### DETAILED DESCRIPTION

Disclosed herein are processes and systems for remediation of per- and polyfluoroalkyl substance (PFAS)-contaminated material.

The binding of PFAS compounds to different materials is governed to a large extent by the surface-active behavior of the PFAS compounds. The fluorinated backbone is both hydrophobic (water repelling) and oleophobic/lipophobic (oil/fat repelling) while the terminal functional group is hydrophilic (water loving). This means that PFAS compounds tend to partition to interfaces, such as between air and water with the fluorinated backbone residing in air and the terminal functional group residing in water. The PFAS partitioning behavior also is affected by the alkyl chain length and the charge on the terminal functional group. In general, PFAS compounds with a shorter alkyl chain length are more water soluble than those with longer lengths. Adsorption to soil surfaces tends to be greater for PFAS compounds with longer alkyl chain length.

At environmentally relevant pH, many PFAS compounds have a negatively charged terminal functional group (i.e., anionic), meaning that they will be repelled from soil that tends to have negatively charged surfaces. Some PFAS compounds have a positively charged terminal functional group (i.e., cation), which strongly bind with soils. And a few PFAS compounds have both positively and negatively charged groups (i.e., zwitterions), which will exhibit partitioning behavior between anionic and cationic compounds.

The processes and systems disclosed herein for remediation of PFAS compounds can address the unique characteristics of PFAS compounds.

The phrase “operably connected to” refers to any form of interaction between two or more entities, including mechanical, electrical, magnetic, electromagnetic, fluid, and thermal interaction. Two entities may interact with each other even though they are not in direct contact with each other. For example, two entities may interact with each other through an intermediate entity.

Disclosed herein are processes and systems for remediation of a per- and polyfluoroalkyl substance (PFAS) compound-contaminated material. For example, the remediation processes may include receiving a feed stream comprising a PFAS compound-contaminated material, introducing the material into a vessel, and heating the material in the vessel for at least 2000 degree F.*minutes above 500° F. to reduce the PFAS compound present in the material below a selected level. As used herein, “degree F.*minutes above 500° F.” is a measure of the area under the curve of a plot of the temperature of the material above 500° F. and the time of the material in the vessel at temperatures above 500° F. Stated another way, “degree F.*minutes above 500° F.” is the integral of the temperature versus time function with a lower limit of 500° F. The degree F.*minutes above 500° F. encompasses the various combinations of temperature and time to achieve a stated “degree F.*minutes”. For example, 2000 degree F.*minutes above 500° F. may be achieved by the material being at 1000° F. for four minutes or by the material being at 1500° F. for two minutes. The degree F.*minutes above 500° F. may be approximated by summing the average temperatures of the material above 500° F. for each minute the material is above 500° F., or by summing average or representative sample temperatures of the material above 500° F. for any shorter or longer period of time.

It may be beneficial to heat the vessel to at least 1200° F. to achieve sufficient heat transfer to the material.

The process may include, prior to the heating step, determining a minimum degree F.*minutes above 500° F. needed to reduce the PFAS compound present in the material below a selected level. That step can include determining specific PFAS compounds, chemical types, or both present in the material and their concentration and utilizing a lookup table to determine the minimum degree F.*minutes above 500° F. needed for the specific PFAS compounds. Chemical types refers to subcategories of PFAS compounds based on chemical features, such as the type of charge of the terminal functional group, alkyl chain length, etc. This determining step may be manual or automatic using the lookup table. The lookup table may be built by testing samples of the material or by testing other samples. Determining the minimum degree F.*minutes above 500° F. needed to reduce the PFAS compound present in the material below the selected level may include performing a bench test on a sample of the material.

Maintaining the material in the vessel for at least 2000 degree F.*minutes above 500° F. may include maintaining the material in the vessel for at least 2500 degree F.*minutes above 500° F., at least 3000 degree F.*minutes above 500° F., at least 3500 degree F.*minutes above 500° F., at least 4000 degree F.*minutes above 500° F., at least 4500 degree F.*minutes above 500° F., or at least 5000 degree F.*minutes above 500° F.

The process may be a continuous, batch, or semi-batch process. In continuous processes, the time spent in the vessel refers to the mean residence time for the material as opposed to a specific residence of any particular particle.

The temperature of the material may be directly measured, indirectly measured, or determined by modeling. The temperature of the vessel and of the air may be measured but those values will generally be different from the temperature of the material in the vessel.

Heating the vessel may include uniformly circumferentially heating the vessel, such as via indirect heat. For example, electrical induction coils may be used to heat the vessel.

The process may include mixing the material within the vessel while maintaining close contact between the material and the interior surface of the vessel. For example, the vessel may include a rotatable barrel and the process may include rotating the material within the vessel while maintaining close contact between the material and the interior surface of the rotatable barrel. Close contact between the material and the interior surface aids in heat transfer to the material when the vessel is indirectly heated. This is in contrast to a direct-fired dryer which optimizes heat transfer to a material by having the hot gas in contact with aerated material solids. In further distinction from a direct-fired dryer, the vessels disclosed herein (e.g., rotatable barrel) may continuously receive atmospheric air (i.e., unheated air) into the vessel during operation (although in some embodiments the feed air may be partially pre-heated, such as up to 350° F.). Close contact with the interior surface of the vessel does not require continuous contact but is greater contact than is achieved by aeration.

Reducing the PFAS compound present in the material below the selected level may include reducing the PFAS compound present to less than 1 microgram of PFAS compound per kilogram of material or to some other level set by a regulatory body. Additionally or alternatively, reducing the PFAS compound present may include reducing the PFAS compound present by at least 95%, at least 10 fold, at least 100 fold, or at least 1000 fold.

The processes may further include separating vapors containing a PFAS compound or partially-decomposed PFAS compound hydrocarbons (e.g., halogenated hydrocarbons) from the material into an impure vapor stream and producing a purified solids stream. Optionally, the impure vapor stream may be condensed to separate a condenser liquid stream from the impure vapor stream. At least a portion of the condenser liquid stream may be recycled to the vessel. Additionally or alternatively, at least a portion of the hydrocarbons from the condenser liquid stream may be removed, such as for use in combustion to generate electricity for the process, commercial sale, or reinjection. The processes may further include removing at least a portion of acid gases from the impure vapor stream. The process may further include removing particulate matter from the impure vapor stream. Removal of hydrocarbons and acid gases may be accomplished via condensation, absorption, or filtering. For example, Applicant has discovered that when heating the material in the vessel for at least 2000 degree F.*minutes above 500° F., the PFAS compound present in the material can largely be volatized into the exhaust stream (a.k.a., impure vapor stream). In such scenarios, the PFAS compounds (and/or partially-decomposed PFAS compounds) in the exhaust stream can be captured by removing particulate solids from the exhaust stream and by condensing liquids out of the exhaust stream. In such embodiments, it may not be necessary to use an afterburner (i.e., thermal oxidizer) to destroy the PFAS compounds. That said, the removal processes discussed in this paragraph may be performed after a thermal oxidation step at 1800° F. to 2300° F. One of skill in the art with the benefit of this disclosure would understand different removal methodologies that could be used. The overarching goal of the separation process is to recover the impurities and provide an environmentally safe exhaust vapor stream.

A portion of the purified solids stream may be recycled back into the vessel. This may aid in preheating the feed stream and/or may reduce the concentration of the PFAS compound in the purified solids stream. For example, it may be desirable to have at least 96% of the purified solids stream meet clean-up standards (e.g., PFAS concentration less than a selected level, such as 1 μg/kg).

The processes may further include operating the vessel at a negative pressure while heating the material. For example, as discussed above, atmospheric air may be continuously drawn into the vessel during steady-state operation.

The processes may further include preheating the material contaminated with the PFAS compound sufficient to volatilize at least a portion of the moisture in the material prior to introducing the material into the vessel.

One or more additive streams, one or more liquid or solid streams from other parts of the process, or combinations thereof may be mixed with the PFAS compound-contaminated material in the feed stream, prior to introducing the material into the vessel. These mixing steps may be used to modify the pH of the feed material to enhance dissociation of particular chemical types of PFAS compounds from certain types of materials (e.g., soil, gravel, etc.) and/or to raise the pH of the exhaust stream(s) to reduce corrosion of process equipment. These mixing steps may also be used to modify the moisture content of the feed material depending upon the aqueous solubility of the particular chemical type of PFAS compounds in the feed material. Additionally, these mixing steps may be used to increase the overall destruction of PFAS compound by the processes.

The processes may include determining a chemical type of the PFAS compound in the material (e.g., alkyl chain length and the charge on the terminal functional group). The process may then be modulated to achieve adequate destruction and/or removal of the PFAS compound, based on the physical properties (e.g., aqueous solubility, vapor pressure) of the type. Exemplary systems for removing a PFAS compound include a vessel configured to receive a feed stream containing PFAS-contaminated material, the vessel comprising a rotatable barrel having a receiving end, a discharging end, an interior surface, and an exterior surface, the rotatable barrel operably coupled to a heater configured to indirectly, circumferentially heat the rotatable barrel to at least 1200° F., and the rotatable barrel configured to maintain the material in the interior of the rotatable barrel for a sufficient period of time to reduce a concentration of the PFAS in the material below a selected level.

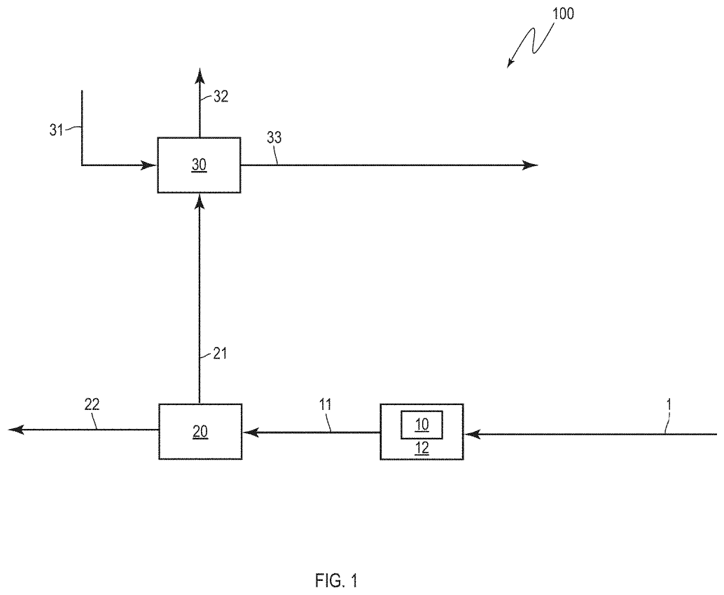

For example, FIG. 1 illustrates a system 100 for removing a PFAS compound. System 100 includes a feed stream 1 containing a PFAS compound-contaminated material. A vessel 10 is operably coupled to a heater 12 (e.g., an inductive or other heater). The vessel 10 may be comprised of different materials. For example, in some embodiments the vessel may be comprised wholly or partially of graphite or stainless steel. The heater 12 is configured to indirectly heat material received in the vessel to a minimum or predetermined temperature. For example, in some embodiments the heater is configured to heat material received in the vessel to at least 1200° F. In some embodiments, the heater is configured to heat material received in the vessel to at least 1250° F., 1300° F., 1350° F., 1400° F., 1500° F., 1600° F., 1700° F., or 1800° F., such as 1200° F. to 1800° F., 1200° F. to 2200° F., 1200° F. to 2000° F., or 1200° F. to less than 2000° F. In some embodiments, rather than being configured to heat material to at least these temperatures, the heater is configured to heat the vessel to an operating temperature of at least 1200° F., 1250° F., 1300° F., 1350° F., 1400° F., 1500° F., 1600° F., 1700° F., 1800° F., 1900° F., 2000° F., 2200° F., 2400° F., such as, 1200° F. to 2400° F., 1200° F. to 2200° F., 1200° F. to 2000° F., or 1200° F. to less than 2000° F., or other minimum operating temperature. The system 100 is configured to maintain the material in the vessel 10 for a sufficient period of time to reduce a concentration of the PFAS compound in the material below a selected level. Or stated another way, the system 100 is configured to achieve a residence time of the material in the vessel 10 for a sufficient period of time to reduce a concentration of the PFAS compound in the material below a selected level. The selected level may be set by an operator of the system 100.

The feed stream 1 may be at atmospheric temperature and pressure. In addition to the PFAS compound-contaminated material, the feed stream 1 may include fresh air. Alternatively, fresh air may be separately supplied to the vessel 10.

The PFAS compound-contaminated material may include different PFAS compounds or may be contaminated with only one PFAS compound.

The material may be any type of material contaminated with a PFAS compound, such as, for example, soil, gravel, rock, and other solid media. The system 100 further includes a separator 20 operably connected to the vessel 10. The separator 20 is configured to separate heated material in output stream 11 from the vessel 10 into an impure vapor stream 21 and a purified solids stream 22. The output stream 11 may be at negative pressure (i.e., a pressure less than atmospheric pressure). The output stream 11 may be 1200° F. to 2500° F., such as 1300° F.

The system 100 further includes a scrubber 30 operably connected to the impure vapor stream 21. In the embodiment illustrated in FIG. 1, the scrubber 30 includes a wet scrubber and is configured to receive an aqueous input stream 31 and to produce a purified vapor stream 32 and a scrubber liquid stream 33. Other embodiments may include different types of scrubbers, such as dry or semi-dry scrubbers.

Although not illustrated, the system 100 may include temperature, pressure, moisture, and pH controllers using feedback and feed-forward control systems and corresponding sensors throughout the system 100. For example, the separator 20 may be operably connected to temperature, pressure, and moisture controllers. In another example, the scrubber 30 may be operably connected to temperature, pressure, and pH controllers. Additionally, the system 100 may include PFAS concentration detection mechanisms that feed data to control systems.

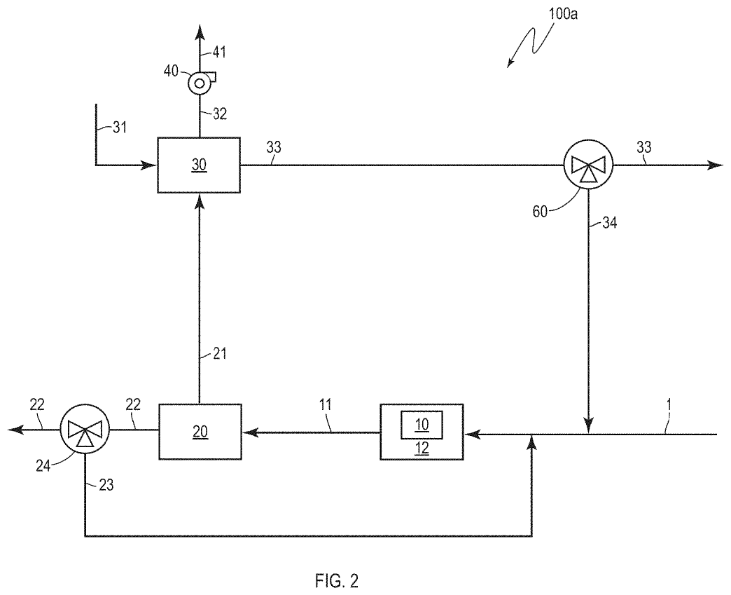

FIG. 2 illustrates a system 100a, which includes all the features of the system 100. Additionally, the system 100a includes a blower 40 operably connected to the purified vapor stream 32 and configured to generate negative pressure in the scrubber 30, the impure vapor stream 32, and the vessel 10. The blower 40 produces exhaust vapor stream 41. The exhaust vapor stream 41 may be controlled to be at atmospheric temperature and pressure. In this embodiment, the scrubber 30 and the vessel 10 (and interconnecting streams and subsystems) are configured for operation at negative pressure.

The system 100a also includes a flow diverter 24 operably connected to the purified solids stream 22 and configured to direct all, a portion, or none of the purified solids stream 22 (via solid recycle stream 23) to the feed stream 1 at a point upstream from the vessel 10. For example, the flow diverter 24 may be an adjustable gate (such as made from a high-temperature compatible superalloy) configured to variably partition the purified solids stream 22 as desired. In certain embodiments, the recycle ratio ranges from 0.1 to 0.9. It should be understood that the purified solids stream 22 and the solid recycle stream 23 may be at least partially molten or liquified; however, upon cooling to atmospheric temperature, the contents of the streams may be solid or partially solid in nature.

The system 100a also includes a controller 60 operably connected to the scrubber liquid stream 33 and configured to direct all, a portion, or none of the scrubber liquid stream 33 (via liquid scrubber stream 34) to the feed stream 1 at a point upstream from the vessel 10, which may be the same or different from the point at which the solid recycle stream 23 encounters the feed stream 1.

In certain embodiments, the liquid scrubber stream 34 may not be present. For example, it may be preferable to further process and/or dispose of the liquid scrubber stream 33.

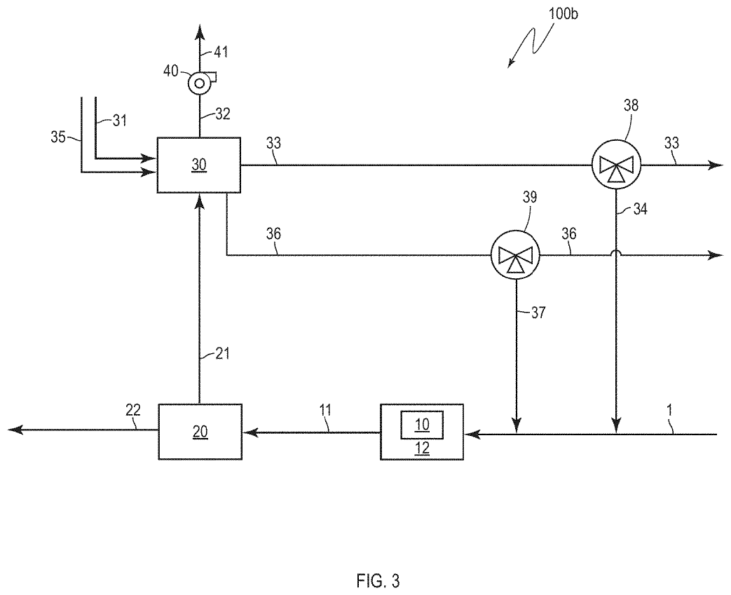

FIG. 3 illustrates a system 100b, which also includes all the features of the system 100. Additionally, the scrubber 30 in the system 100b is configured to receive an additive stream 35. For example, sodium hydroxide or other neutralizers may be an additive used to remove acid gases. The additive stream 35 is illustrated as separate from the clean water input stream 31 but may be combined with the clean water input stream 31. In the embodiment illustrated in FIG. 3, the scrubber 30 is configured to produce a solid precipitant in a solid scrubber stream 36.

The system 100b includes a controller 39 operably connected to the solid scrubber stream 36 and configured to direct all, a portion, or none of the solid scrubber stream 36 (via solid scrubber stream 37) to the feed stream 1 at a point upstream from the vessel 10, which may be the same or different from the point at which the solid recycle stream 23 encounters the feed stream 1 and the same or different from the point at which the liquid scrubber stream 34 encounters the feed stream 1.

In certain embodiments, the solid scrubber stream 37 may not be present. For example, when the additive is limestone (calcium carbonate) and the solid scrubber stream 36 is primarily gypsum (calcium sulfate), it may be preferable to stockpile the gypsum for later disposal or sale.

It should be understood that any controller known in the art, such as a three-way valve, and compatible with the materials being handled may be used as the controller 39. This also applies to the other flow controllers and diverters disclosed herein.

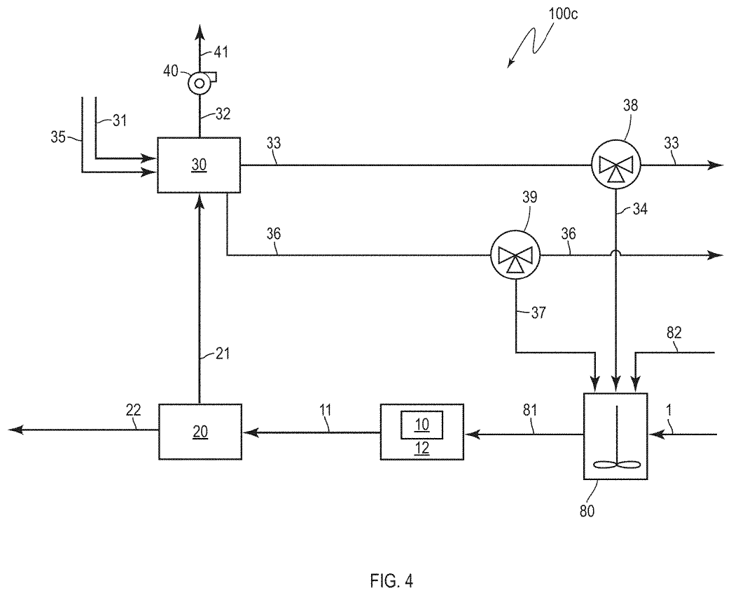

FIG. 4 illustrates a system 100c, which also includes all the features of the system 100b. In the system 100c, the liquid scrubber stream 34 and the solid scrubber stream 37 combine with the feed stream 1 in a mixer 80 to produce a modified feed stream 81. In the illustrated embodiment of FIG. 4, an additive stream 82 also feeds into the mixer 80.

Various types of mixers may be used, depending on the range of materials to be processed, such as, by way of non-limiting example, augers or other rotary mixers. Where the system 100c may be designed for handling a variety of materials, then it may be desirable to provide a mixer that is sufficiently robust for the most difficult of materials. This can be particularly true when the system 100c is configured for mobile operation and use at multiple sites.

The mixer 80 (and the overall system 100c) may be configured with multiple connections for numerous inputs and outputs that may not all be used at each site and for each type of PFAS compound. For example, for a site contaminated with a PFAS compound that is highly water soluble, such as perfluorooctanoic acid (PFOA) with an estimated water solubility of 9,500 mg/L, it may be desirable to increase the moisture content of the feed stream 1. This could be done via the additive stream 82, the liquid scrubber stream 34, or other liquid streams in the system. Additionally, when the material is soil, it may be desirable to maintain the pH of the PFOA-contaminated material at environmental pH to maintain repulsion of the PFOA from the soil.

In another example, for a site with soil contaminated with a PFAS compound that is less water soluble, such as perfluorooctane sulfonate (PFOS) with an estimated water solubility of 680 mg/L, it may not be beneficial to increase the moisture content of the feed stream 1. However, it may be beneficial to tailor the pH of the feed stream 1 to enhance repulsion of the PFOS from the soil. In that example, the mixer 80 may include connections to the liquid scrubber stream 34. That said, those connections may not be used and/or the controller 38 may prevent any flow into the liquid scrubber stream 34.

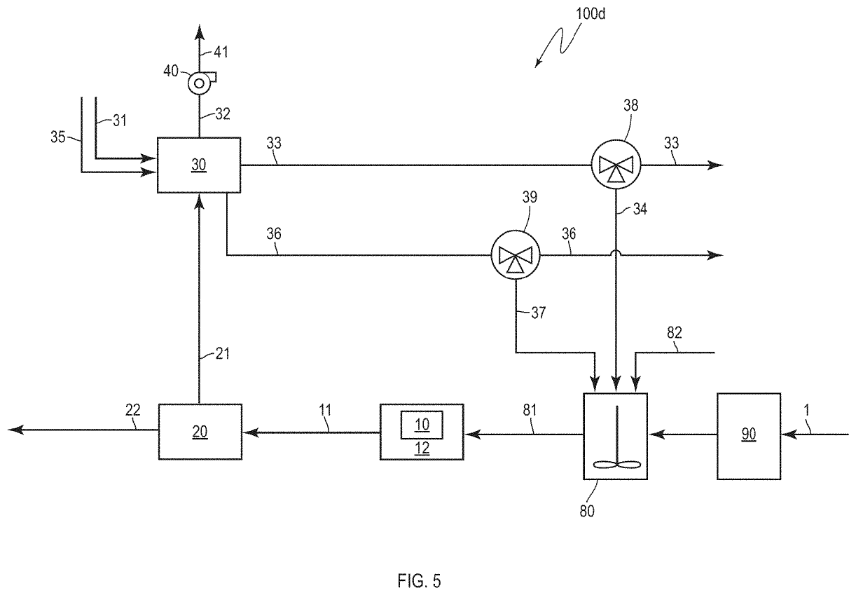

FIG. 5 illustrates a system 100d, which also includes all the features of the system 100b. The system 100d includes a mill 90 operably connected to the feed stream 1 at a point upstream from the vessel 10 and configured to crush the PFAS compound-contaminated material in the feed stream to a desired size. In the illustrated embodiment of FIG. 5, the mill 90 is upstream of the mixer 80 and produces a milled feed 91. Non-limiting examples of the mill 90 include ball mills and hammer mills.

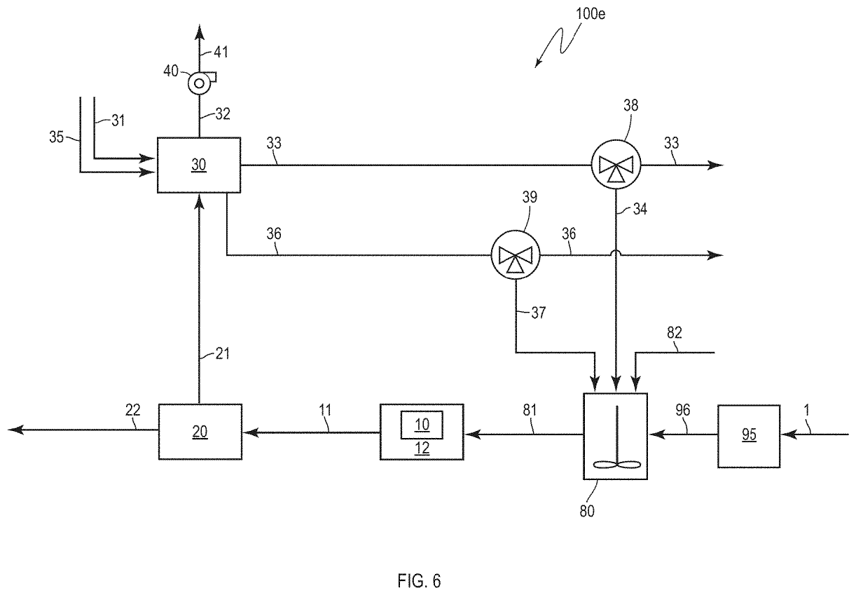

FIG. 6 illustrates a system 100e, which also includes all the features of the system 100b. The system 100e includes a preheater 95 operably connected to the feed stream 1 at a point upstream from the vessel 10 and configured to at least partially volatilize moisture present in the PFAS compound-contaminated material in the feed stream 1. In the illustrated embodiment of FIG. 6, the preheater 95 is upstream of the mixer 80 and produces a preheated feed 96. Alternatively or additionally, a portion of recycled purified solids stream 22 may be used to preheat the feed stream 1.

In particular embodiments, the preheater 95 may be a tank or steel box with steam-pipes running through it and/or an access port connected to an air-heater too. In such embodiments, this portion of the system would likely be operated as a batch process. For example, a batch of the material in the feed stream 1 may be heated for 8 to 24 hours. The preheated feed 96 may then be continuously or batch-wise fed to the mixer 80.

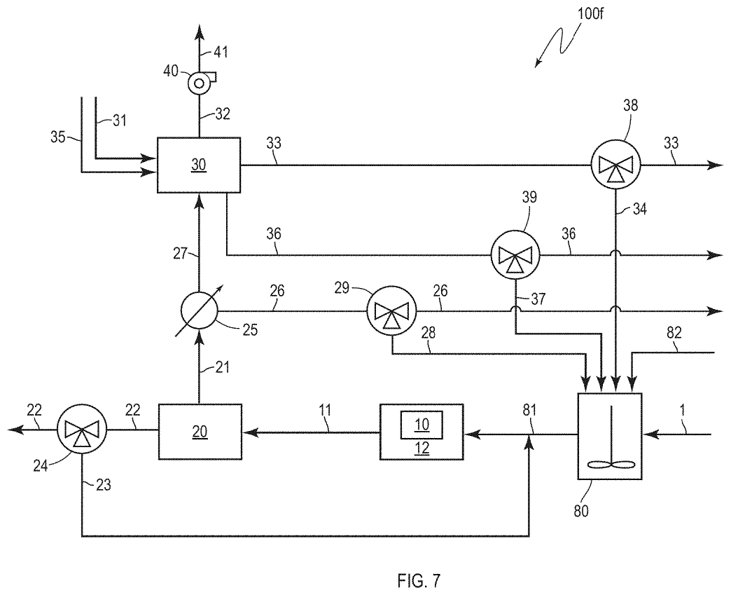

FIG. 7 illustrates a system 100f, which also includes all the features of the system 100b. The system 100f includes a condenser 25 operably connected to the impure vapor stream 21 upstream of the scrubber 30. The impure vapor stream 21 may be similar in temperature to the output stream 11. The impure vapor stream 21 may contain acid gases, PFAS compound, partially-decomposed PFAS compound hydrocarbons, other hydrocarbons, and trace solids. The condenser 25 is configured to separate a condenser liquid stream 26 from the impure vapor stream 21 to produce a simplified impure vapor stream 27.

The condenser liquid stream 26 may include contaminated water and/or the PFAS compound or partially-decomposed PFAS compound hydrocarbons. The condenser liquid stream 26 may also include hydrocarbons from other sources, such as from other organic compounds in the material.

The simplified impure vapor stream 27 may contain acid gases and residual PFAS compound or hydrocarbons. In some embodiments, the simplified impure vapor stream 27 is at a negative pressure and/or at a temperature less than 212° F.

The system 100f includes a controller 29 operably connected to the condenser liquid stream 26 and configured to direct all, a portion, or none of the condenser liquid stream 26 (via condenser liquid stream 28) to the feed stream 1 at a point upstream from the vessel 10. In the illustrated embodiment of FIG. 7, the condenser liquid stream 28 feeds into the mixer 80.

The presentation of different system features in FIGS. 1-7 is not limiting. It should be understood that in different embodiments any or none of the features shown in FIGS. 1-7 may be combined with each other, even if not specifically illustrated. For example, a system 100 in various embodiments may be modified to include one or more of the controller 60 and flow diverter 24 illustrated in FIG. 2. In other embodiments, a system may similarly have one or more of any system feature shown in FIGS. 1-7.

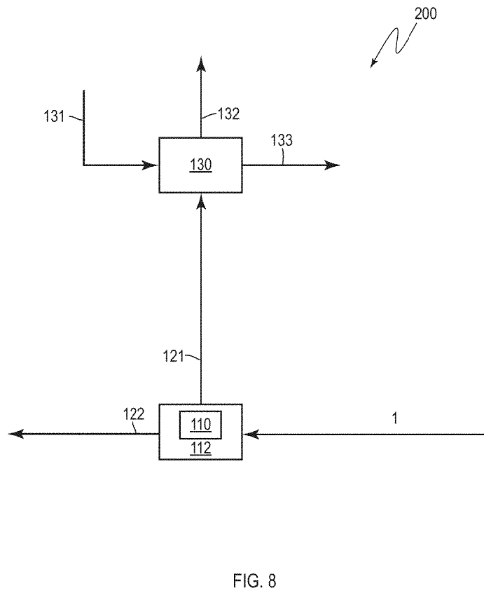

FIG. 8 illustrates another embodiment of a system 200 for removing a PFAS compound. The system 200 includes all of the features of the system 100, except that a separator 20 as a distinct unit operation is not present. Instead, the vessel 110 (operably coupled to heater 112, which in some embodiments is an inductive heater) includes a vent configured to release an impure vapor stream 121 from the vessel 110 and thereby separate vapors from the solids in the material. The vessel 10 is also configured to produce a purified solids stream 122.

The scrubber 130 includes the same streams and options as the scrubber 30 in the system 100.

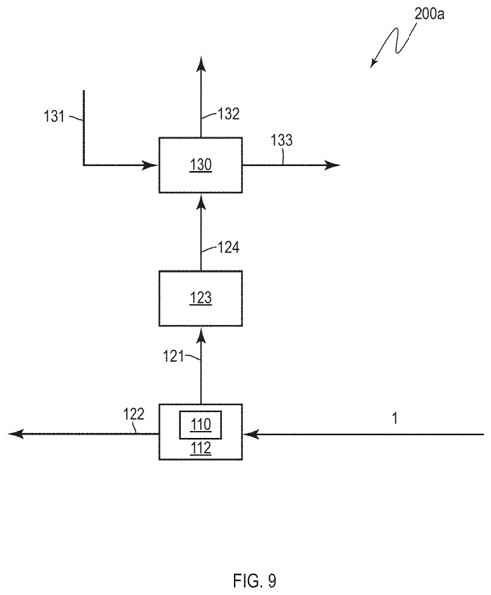

FIG. 9 illustrates a system 200a, which includes all the features of the system 200. The system 200a includes an afterburner 123 operably coupled to the vessel 110, such as via the vent. The afterburner 123 is configured to burn combustible vapors and gases in the impure vapor stream 121. “Combustible vapors and gases” refers to vapors and gases capable of combustion at the operating temperature of the afterburner. The afterburner 123 may operate at a temperature greater than 1800° F., such as 2000° F. to 2500° F.

The afterburner 123 is illustrated as separate from the vessel 110 but can be directly connected to the vessel 110. The afterburner 123 produces a flue gas stream 124, which is operably coupled to the scrubber 130. The afterburner 123 may be used instead of a condenser. Alternatively, a condenser may still be operably coupled to the flue gas stream 124.

In embodiments that include the afterburner, the vessel 110 (or the vessel 10) may only be heated to 1500° F., such as 1200° F. to 1500° F. Relatedly, when using the afterburner, the heater may be configured to heat material received in the vessel to 1500° F., such as 1200° F. to 1500° F.

All of the options discussed above regarding the system 100 and FIGS. 2-7 apply to the system 200. Likewise, all of the options discussed above regarding the system 200 and FIGS. 8 and 9 apply to the system 100. For example, an afterburner may be operably coupled to the separator 20 and configured to burn combustible vapors and gases in the impure vapor stream 21.

The system 100 and the system 200 may be configured for mobile operation, such that the systems may be moved from site-to-site. The system components may be configured and sized for transport by tractor-trailer, such as by flatbed, or by shipping container, such as a standard forty foot shipping container.

In certain embodiments, the systems and processes disclosed herein are configured for operation at temperatures lower than the incineration temperatures for the chemical type of PFAS in the material. Meanwhile, in such embodiments, the flue gas produced may be cleaner than that produced by incineration (e.g., the amount of PFAS released into the atmosphere may be less and/or the amount of fluorinated by-products released to atmosphere may be less). Therefore, certain embodiments of the systems and processes disclosed herein may use less energy than incineration (due to lower temperatures) and may be safer for the environment.

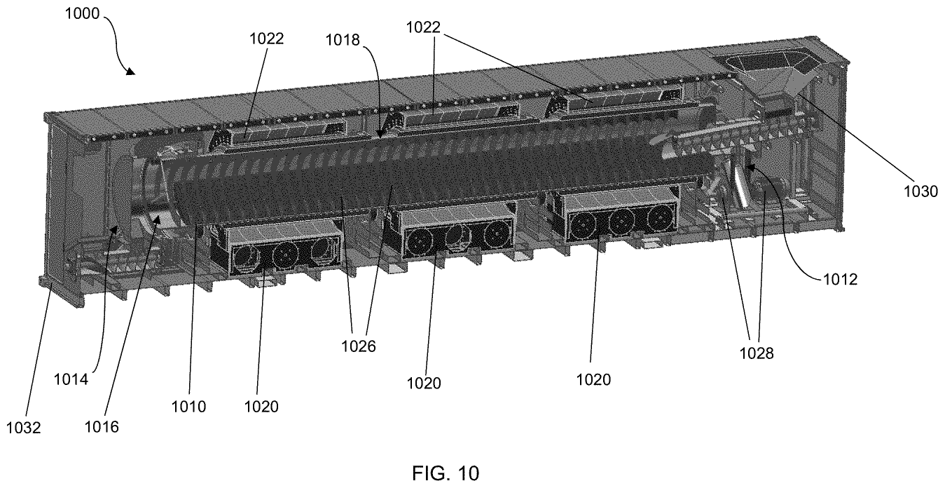

FIG. 10 illustrates a system 1000 for removing contaminants. The system 1000 can be used as the vessel 10 and the heater 12 (or the vessel 110 and the heater 112) in any of the embodiments of FIGS. 1-9. The system 1000 includes a rotatable barrel 1010 having a receiving end 1012, a discharging end 1014, an interior surface 1016, and an exterior surface 1018. The rotatable barrel 1010 is operably coupled to a heater 1020 comprising an induction coil 1022 configured to indirectly, circumferentially heat the rotatable barrel 1010 to varying temperatures, such as at least 1350° F.

In this illustrated embodiment, the rotatable barrel 1010 is configured for horizontal operation. The interior surface 1016 of the rotatable barrel 1010 comprises lifting flights (not illustrated) configured to aid in circulating material within the rotatable barrel 1010 and advancing flights 1026 configured to advance material from the receiving end 1012 to the discharging end 1014.

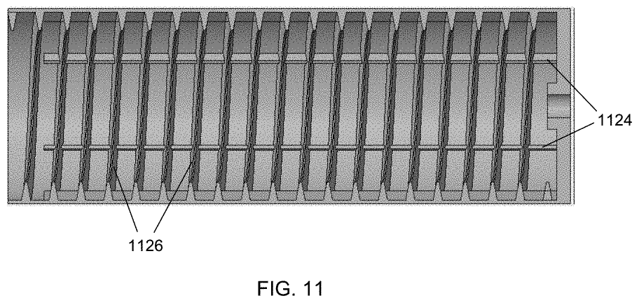

In this embodiment, the length of the lifting flights (see, e.g., FIG. 11) is axially aligned with a longitudinal axis of the rotatable barrel 1010 and the lifting flights protrude from and are circumferentially spaced around the interior surface 1016 of the rotatable barrel 1010. The height of the lifting flights may be less than the height of the advancing flights, such as a two-thirds ratio. Additionally, the lifting flights may have a negative angle of repose. The “angle of repose” (AOR) is the angle of a lifting flight (LF) with respect to the central longitudinal axis of rotation in the rotatable barrel. If the LFs point straight towards intersecting the longitudinal axis, this is considered a zero degree AOR. If the LFs are angled “down” (below the central axis), the LFs have a negative AOR, while LFs angled “up” (above the central axis) have a positive AOR.

In the illustrated embodiment, the length of the advancing flights 1026 is orientated transverse to the lifting flights and the advancing flights 1026 protrude from and are helically spaced around the interior surface 1016 of the rotatable barrel 1010.

The system 1000 includes a rotary mechanism (and rotary support structure) 1028 operatively coupled to the rotatable barrel 1010. In particular embodiments, the rotary mechanism 1028 is configured to rotate the rotatable barrel 1010 at a speed of one to eight rotations per minute.

In the system 1000, the heater 1020 includes an induction coil circumscribing the exterior surface 1018 of the rotatable barrel 1010.

System 1000 includes a feed hopper 1030 operatively coupled to the receiving end 1012 of the rotatable barrel 1010.

In the illustrated embodiment, the system 1000 fits within a standard forty foot shipping container. For certain barrel diameters, the rotatable barrel 1010 must be configured to be parallel to the floor and ceiling of the shipping container (i.e., configured for horizontal operation), to allow room for the induction coils of heater 1020, the rotary mechanism (and rotary support structure) 1028, and the feed hopper 1030. In such embodiments, the rotatable barrel 1010 may include lifting flights and advancing flights (such as lifting flights 1124 and advancing flights 1026 or 1126).

By way of non-limiting example, the system 1000 may be used with solid and semi-solid materials with a wide array of particle size distributions, soil types, organic content, and moisture content.

In addition to the system 1000 being in a shipping container, a mobile multi-tap transformer and associated switchgear can also be in a separate shipping container. The transformer can be used to connect a high voltage power supply to the system 1000.

Additionally, a third shipping container may contain the process equipment for cleaning the vapor-phase effluent (e.g., impure vapor stream 21 or 121) exiting the rotatable barrel 1010. The third shipping container may include a cyclone and baghouse for removing particulate matter from the impure vapor stream 21 or 121, afterburner, and quench cooler. Alternatively, in embodiments where the contaminants are sufficiently destroyed in the rotatable barrel 1010, the third shipping container does not include the afterburner.

In an alternative to the illustrated embodiment, the rotatable barrel may be configured for declined angle operation. In such embodiments, the interior of the rotatable barrel would include lifting flights configured to aid in circulating material within the rotatable barrel but would not necessarily need advancing flights.

In any of the systems disclosed herein, a sufficient period of time to reduce the concentration of the PFAS in the material below the selected level may involve maintaining the material in the vessel (such as the rotatable barrel) for at least 2000 degree F.*minutes above 500° F.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art, and having the benefit of this disclosure, that changes may be made to the details of the above-described embodiments without departing from the underlying principles of the disclosure herein.

### EXAMPLES

### Example 1—Barrel Scale Model Testing

Scale models of rotatable barrels in accordance with the present disclosure were 3-D printed with different flighting options to evaluate effects of flight design on the movement of soil through the vessel. The tested configurations are listed in Table 1.

TABLE 1
Flighting configurations of five devices under test (DUTs) tested for material retention time.

| | Flighting | AF | AF | AF | AF | # ang. | LF | LF | # axial LF | LF AOR |
|---|---|---|---|---|---|---|---|---|---|---|
| DUT | type | Pitch | Height | Length | #sections | LFs | Height | Length | sections | (−deg) |
| 1 | FULL | 6 | 4 | 120 | 1 | 6 | 4.5 | 120 | 1 | 20 |
| 2 | FULL | 6 | 4 | 120 | 1 | 6 | 2 | 120 | 1 | 20 |
| 3 | AGP | 6 | 4 | 18 | 4 | 4 | 2 | 120 | 1 | 20 |
| 4 | AGP | 12 | 4 | 24 | 2 | 8 | 2 | 12 | 6 | 20 |
| 5 | ARGP | 6 | 4 | 12 | 5 | 3 | 4 | 120 | 1 | 0 |

AF = advancing flight;
AGP = axial gap (longitudinal regions without advancing flights);
AOR = angle of repose;
ARGP = axial radial gap (longitudinal regions without advancing flights, plus discontinuous helices of the advancing flights);
LF = lifting flight.

To the extent possible, the models were printed to 1/25.4 scale (original dimensions in inches, model dimensions in mm). Each device under test (DUT) was placed in a 3-D printed fixture and driven by a stepper motor belt drive. The fixture was put on a 3-D printed leveling plate equipped with four M3 screws having a pitch of 0.5 mm for use in adjusting the declination angle (tilt) of the plate. The two rows of M3 screws were 140 mm apart, so the declination angle was calculated by taking the arctangent of the height difference in the two rows of screws, divided by 140 mm. The height difference was found by counting turns of the M3 screws. A digital level was used to identify the horizontal configuration, and to double-check the calculated declination angle. Play sand, i.e., the type used in children's sandboxes, was used to simulate soil samples. Each trial was performed according to the following protocol:
1. Pick up the entire test fixture and tilt it so that the barrel opening is pointing up;
2. Add 1 tablespoon of sand and shake the test fixture until all sand has settled to the bottom;
3. Place the DUT on the work bench so that the video camera is aimed down the barrel;
4. Record the DUT number, RPM setting, declination angle, and trial number
5. Start recording video;
6. Connect the stepper controller to 12 V power to start it;
7. Run the stepper motor until sand is no longer exiting the barrel;
8. Save the video file; and
9. Dump the sand from the leveling table into the sample receptable and clean out the DUT before running the next trial.

The number of revolutions needed to move the entire sand sample through the DUT was measured by counting the number of revolutions (200 steps per revolution) of the stepper motor for each trial. The volume of the sand sample was measured with a teaspoon (1 tsp=5 ml). If a significant amount of sand remained stuck in the vessel after the trial, this was noted in the results.

The rotational speed in rpm was calculated from the motor's steps per revolution and held constant throughout each trial. Trials were run at two speeds (6 rpm and 30 rpm), to observe whether rotational speed had a significant effect on the number of revolutions it took for the sand to traverse the vessel.

Sand samples were found to traverse through each of the DUTs at rates having varied dependence on inclination angle. One of the DUTs tested (“DUT 2” in Table 1, a cross-section diagram of which is shown in FIG. 11), had one continuous helical advancing flight 1126 (pitch=6; height=4 mm) and six 2 mm high lifting flights 1124 having a −20° angle of repose (AOR). The advancing and lifting flights each extended substantially the full length of the vessel barrel (120 mm). This DUT moved sand in a predictable manner, taking about 12-13 revolutions to distribute the sand into its flights and 8-9 more revolutions to evacuate all flights. These results were substantially independent of inclination angle.

By contrast, DUT 1, which has 4.5 mm tall lifting flights (0.5 mm taller than the 4 mm helical advancing flights), did not evacuate all its dirt in nearly 100 revolutions. It appears that because the lifting flights were taller than the advancing flights, the dirt did not follow the advancing flights well, instead simply tumbled over them.

DUTs 3, 4 and 5 only used a few advancing flights and relied on declination angle plus the agitation caused by the lifting flights to move the dirt down the barrel. These DUTs needed a declination angle to function properly, and the number of revolutions needed to evacuate all the dirt was dependent on how large the declination angle was.

No strong correlation was found between RPM and the number of turns needed to evacuate dirt from the barrel.

### Example 2—PFAS Desorption Bench Scale Testing

A bench test was designed and executed to evaluate the potential to desorb six regulated PFAS compounds from contaminated soil to below regulatory limits, as well as to evaluate the characteristics of the treatment technology. The process used to determine the degree F.*minutes above 500° F. useful for these example samples can be applied to other soils and to other compounds.

A. Bench Scale Treatment Unit Description

The bench scale treatment unit consisted of a variable speed rotating reaction chamber (barrel), a scaled induction heating unit, a controlled air flow system, as well as ancillary equipment to maintain system operations. The bench unit allowed the manipulation of several variables including the barrel wall temperature, air supply temperature, air flow rate, time that the reaction chamber was at target temperature (residence time), and barrel rotation rate. In addition to the control and measurement of these variables, moisture in the soil, pressure inside the barrel, air samples, and several other data points were captured both digitally and by hand. The bench scale unit was divided into two systems referred to as the “main” section and the “accessory” section.

The main section of the bench scale treatment unit consisted of the following components:
Reaction chamber—The reaction chamber or “barrel” consisted of a steel tube with integrated flights, a welded cap and axle connection on one end of the tube, and a removable cap on the other. The barrel was constructed of 310 Stainless Steel, which was selected for its combination of high working temperature, susceptibility to induction heat, and corrosion resistance. The barrel was used to contain the contaminated sample and provide the environment where the sample was thermally treated.
Induction drive—The drive induced an electromagnetic field to heat the barrel indirectly. The induction drive used a controller to set the temperature and the duration the barrel was heated.
Chiller—This piece of equipment circulated cool water through the induction coil at the correct temperature to prevent condensation, from forming and damaging the induction drive.
Motor—The motor rotated the barrel at a set number of revolutions per minute (rpm) to ensure even heating of the barrel wall and even mixing of the soil inside the barrel to control the contact time between the soil and the barrel wall.
Heat sink—The heat sink trapped the heat travelling away from the barrel along the equipment train to prevent downstream systems being damaged from excess heat.
Temperature measurement tools—A variety of tools, including several thermocouples and hand-held temperature measurement devices, were used to capture data in the main section and to ensure the unit was operating safely.
Negative pressure gauge—This was used to collect data associated with the flow of air through the main section and as a safety tool to ensure the bench unit was functioning properly.

The accessory section consisted primarily of the air flow management system and the associated data collection devices coincident with this portion of the bench unit. Air was introduced to the bench unit through a controlled inlet at a known flow rate and at atmospheric temperature. Inlet air flowed through an annulus located in the axle that was connected to and extended into the barrel. Exhaust air was then drawn out of the barrel through tubing located within the annulus of the axle. Negative pressure was generated through a fan-driven vacuum located at the end of the exhaust gas system and measured by a down-stream negative presure gauge. Hot exhaust gasses drawn from the barrel were cooled by passing a coil of exhaust tubing through a water bath before being measured through a flowmeter, and then exhausted from the system.

B. Bench Scale Treatment Unit Operation

The operation of the bench scale treatment unit involved loading the barrel with contaminated soil, resetting and actuating the data collection system, setting the rotational speed of the barrel, setting the air flow, setting the temperature of the induction heating system, and determining the duration of the test to establish the contaminated soil residence time in the barrel. From the point each test began, the system was closely monitored and the operating parameters, including temperature (in three locations), pressure (in the main and the accessory sections), flow rate (at the outlet of the accessory section), and the rotational speed of the barrel, were recorded for the duration of the test.

i. Temperature

Temperature was measured at the three thermocouples in the main section, and identified as Temp.0, Temp.1, and Temp.2. Temperature data was collected by a data acquisition box and imported into a LabVIEW (National Instruments; Austin, Tex.) program created specifically to collect this data. Acquired data was then imported into a spreadsheet where it could effectively be analyzed. In addition to the three thermocouples, two external temperature measurement tools were also used to monitor and evaluate temperatures in the system. A temperature controller linked to an an infrared temperature measurement system and a proportional-integral-derivative (PID) controller was used to set the temperature of the induction drive. The infrared monitoring unit was aimed at the top of the barrel facing downward approximately 11 inches from the barrel surface. The second temperature measurement device was a hand-held infrared thermometer with a maximum temperature limit of 1500° F. The hand-held unit was used to verify the outer temperature of the barrel, axle, and tubing. The locations and operating considerations for the three thermocouples were as follows:

Temp.0: The Temp.0 thermocouple was located in the accessory section on the cold air inlet line before the connection to the axle annulus. Inlet air was introduced at ambient temperature and rarely exceeded 68.5° F., regardless of the operating temperature of the barrel. The inlet air temperature was monitored continuously as a mechanism to identify a blockage in the air flow system or an indication that the system was no longer under negative pressure (indicated by a temperature increase at the Temp.0 thermocouple as air was beginning to flow back out of the inlet).

Temp.1: The Temp.1 thermocouple was located in the tubing exiting the axle carrying the heated air that had traveled back down the axle through the inner tubing. The temperatures that were measured here were dependent on flow rate and provided a separate mechanism to monitor and characterize the exhaust gas flow rate.

Temp.2: The Temp.2 thermocouple measured the temperature of the exhaust as it exited the hot barrel and entered the inner tubing of the axle. This measurement of air temperature was most closely tied to the temperature of the material in the barrel and provided a representative characterization of outlet exhaust gas. Evaluation of the temperature data from the Temp.2 thermocouple identified a correlation with the barrel temperature and was typically 100-300° F. lower than the temperature of the barrel itself.

ii. Pressure

Pressure was measured in both the main section and the accessory section. Pressure was measured in negative inches of Mercury (in. Hg) as the system is designed to operate under negative pressure. The first pressure gauge was co-located with the Temp.1 thermocouple and was used primarily as confirmation that air was free flowing in the system. The second pressure gauge was located in the accessory section, directly before the system outlet and associated valve. This pressure gauge was used to measure any significant pressure drop between it and the first pressure gauge. Both pressure gauges were used to regulate and ensure negative pressure across the system to ensure acceptable operating conditions in the bench unit.

iii. Flow Rate

The exhaust gas flow rate was measured on the flowmeter situated directly after the exhaust gas water bath cooling system in the accessory section. The flowmeter characterized the flow rate of the air through the system in standard cubic feet per minute (scfm). Under a typical testing scenario, the flow rate was established before the induction drive was turned on and then maintained at a steady state for the duration of the test run. It was noted that flow rate was often not constant for the duration of a test run due to changing conditions in the air flow system.

iv. Rotational Speed

Rotational speed was set using a control box incorporated into the bench test unit and varied from 3.4 to 11.6 rpm. The rotational speed was varied to represent greater or lesser agitation of the sample material and a corresponding increase or decrease in the contact time between soil particles and the barrel wall. Four metal hitches were installed in the barrel to model the lifting flights in the full scale barrel.

C. Pre-Treatment of Contaminated Soil

Contaminated soil was collected from three different PFAS-contaminated sites. While all material sources were believed to originate from historic aqueous film forming foam (AFFF) releases, sourcing contaminated material from three different sites incorporated the variable of soil type, the history of the release, and the AFFF formulation into the test. These variables were not controlled for the purposes of this test but did provide opportunity to evaluate variability in the test results should that occur. The samples and their source sites are described as follows:

Sample A: This sample was collected from an area (Site A) considered to have experienced a more recent AFFF release. This soil and specifically the nature and degree of PFAS contamination would be considered representative of the material typically found following the use of AFFF to control a hydrocarbon fire.

Sample B: This sample was taken from an area (Site B) characterized by sandy soil with lower levels of contamination.

Sample C: This sample was collected from the same geographic location as Sample B, but in an area (Site C) representing organic material with higher levels of contamination.

Sample D: This sample was collected from an area (Site D) considered to have experienced an older AFFF release. This site would be representative of the lower end of PFAS contamination.

Samples were prepared by first removing any rocks that were too large to fit inside the reaction chamber. The soil was then sifted through particle size distribution (PSD) sieves. These fractions included the 16, 20, 30, 40, 70, and 140 mesh sizes. The average particle size distributions of each sample are shown in Table 2.

TABLE 2
Average Particle Size Distribution (PSD) by percentage of
soil samples collected from PFAS-contaminated sites.
(No PSD was taken from Sample C due to
the presence of high organic material with little soil.)

| | Average PSD (%) | | | | | |
|---|---|---|---|---|---|---|
| Sample | 16 | 20 | 30 | 40 | 70 | 140 |
| A | 74.1 | 1.8 | 10.9 | 6.1 | 4.9 | 2.2 |
| B | 3 | 24.2 | 47 | 9.4 | 14.1 | 2.3 |
| D | 79.5 | 4.9 | 6 | 3.3 | 4 | 2.3 |

Each fraction was weighed and divided into equal-sized piles. The fractions were then recombined to create six (6) equal samples with a PSD representative of the original source soil. One sample was immediately placed in a sample collection bottle to serve as a control. The rest of the samples were stored in a plastic resealable bag until ready for use.
All test equipment was cleaned and decontaminated prior to use. A clean area was established for handling the samples.

D. Treated Soil—Analytical Results

i. Desorption of Regulated PFAS Compounds

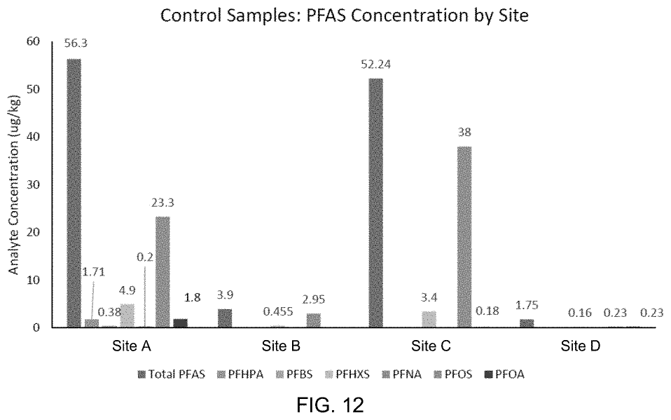

FIG. 12 shows the concentration of PFAS compounds having known regulatory significance (PFOS, PFOA, PFNA, PFHXS, PFHPA, and PFBS) in untreated soil from each sample. Treatment time and temperature were found to be dominant factors influencing PFAS desorption behavior. The combination of these two variables provided a very strong relationship and were identified as a target variable for system optimization.

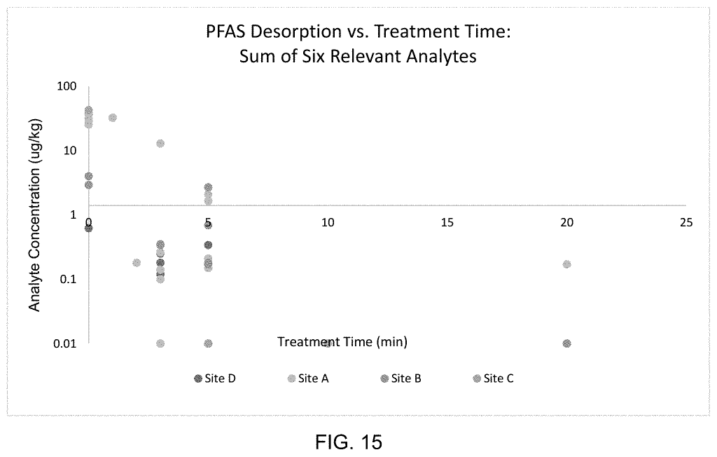

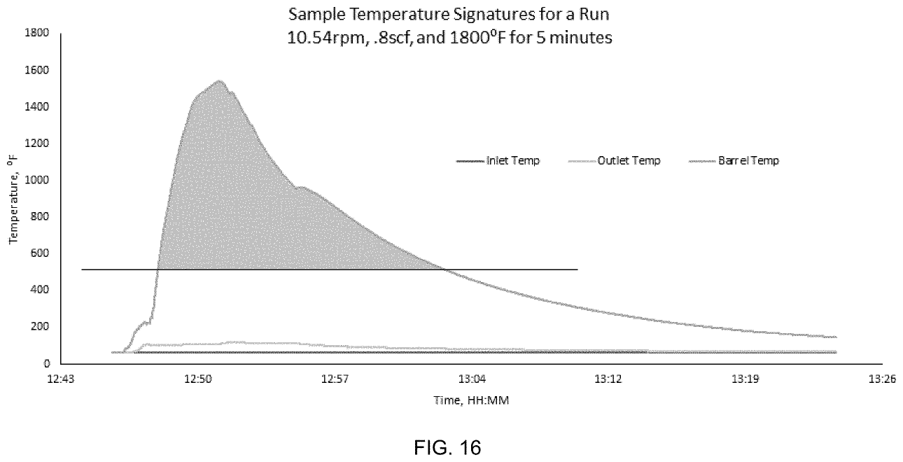

As shown in FIG. 15, PFAS desorption behavior was found to be sensitive to treatment time. Concentrations of all 6 regulated analytes generally trended below the applicable regulatory limit within 5 minutes of treatment time. The analysis showed that PFAS desorption behavior was driven by treatment time. The removal percentage increased significantly over the 1-5 minute range, and then leveled off for longer treatments at near 100% removal. However, some ‘hits’ still existed at higher treatment times, indicating that temperature and other variables might be examined separately.

As shown in FIG. 14, maximum barrel temperature was also an important driver of PFAS desorption, although correlating less strongly than treatment time. It was noted that several runs with a barrel temperature at 1800° F. failed to desorb PFAS in useful quantities.

Taken together, treatment time and barrel temperature dictate the amount of thermal energy imparted to the soil. Accordingly, it was observed that the rate of desorption of PFAS was related to both time and temperature. In general, higher temperature and treatment time resulted in lower residual PFAS concentrations. The most effective desorption was observed for particular combinations of these parameters. For example, certain test runs featured a barrel temperature of 1800° F. for a single minute. This did not allow enough time for the sample to heat all the way up to desorption temperature, despite the barrel operating at the top of its temperature range. Conversely, higher treatment times at lower temperatures were somewhat effective, but less so than higher treatment times at higher temperatures.

Furthermore, treatment time and target temperature, while attractive from a process control standpoint, were found to be imperfect parameters for description of the desorption conditions. The metric “degree-minutes above 500° F.” represents both time and temperature in a single variable and starts at a point generally close to where relevant PFAS compounds start to volatilize. It can be calculated by integrating the time/temperature curve of the measured environment inside the barrel, with a lower limit of 500° F.

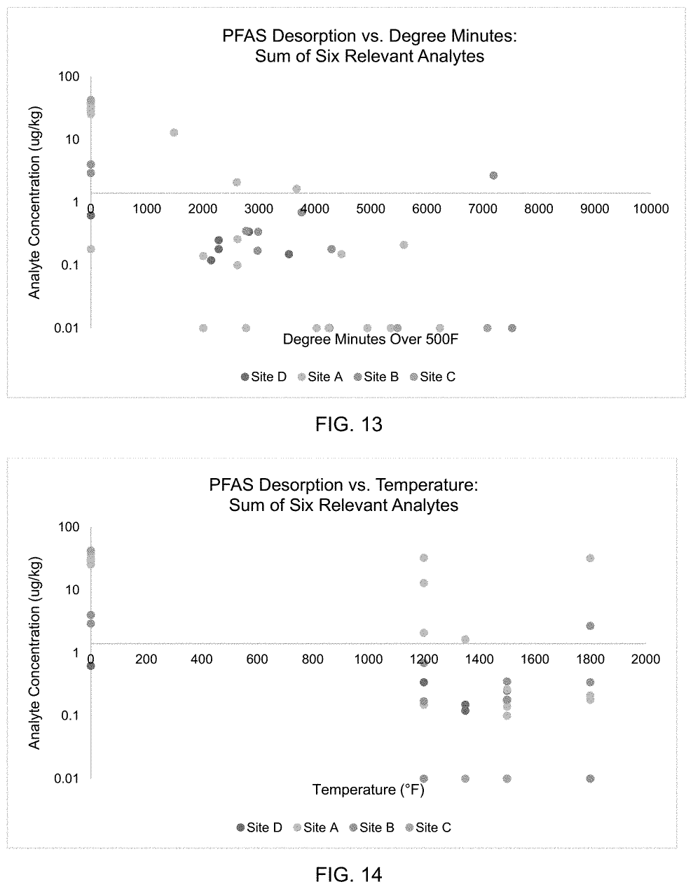

As shown in FIG. 13, overall PFAS desorption performance for all six analytes correlated well with this metric.

### Example 3—Vapor Phase Effluent Testing

A source test was conducted of the vapor-phase effluent produced during the thermal desorption of PFAS from a quantity of contaminated material. This test was completed to further evaluate the exhaust gas exiting the reaction chamber and to obtain additional knowledge regarding the effect thermal desorption was having on the PFAS compounds present in the contaminated material. The final destruction of PFAS compounds and the separation of fluorine from carbon can be performed in a high temperature thermal oxidizer. This PFAS destruction process has been demonstrated to effectively destroy measurable PFAS compounds. However, the desorption process may also affect the various PFAS compounds identified in the contaminated soil. Therefore, source testing was undertaken to provide additional data as to the mechanisms that are in play as PFAS compounds are mobilized during the desorption phase of treatment.

A. Air Emissions Operations and Test Conditions

Samples collected from the pre-treatment contaminated soils and the post-treatment remediated soils were analyzed by an accredited laboratory pursuant to DoD QSM Table B-15. Exhaust gases were captured in a MM-05 (modified) train using Modified Method 0010 (MM-5). The contents of the train were analyzed per EPA Method 537 (modified).

To complete the source test, the accessory section of the treatment unit was disconnected, and the MM5 sample train was attached directly to the bench test unit outlet with a 3-foot section of ⅝-inch stainless steel tubing. The sample train was equipped with a sample pump that replaced the need for the exhaust fan. The air flow rate was set by adjusting a control knob on the dry gas meter box. The meter box is also equipped with a sample flow orifice and a gas meter accurate to 0.001 scfm.

Following connection of the sample train, the bench unit and ancillary equipment was brought on-line following the procedures detailed above. The bench unit was operated, and the individual samples were pre-treated, treated, and post-treated following all of the procedures developed for the bench test program. During source testing, air was pulled through the bench unit until cooled. After the reaction chamber cooled to 100° F., the barrel was unflanged to remove the treated soil and that treated soil was placed into a sample container for laboratory analysis. This process was be repeated three times for each source air run.

Source test runs were completed at different barrel temperatures, 1200° F. (10 min), 1500° F. (5 min) and 1800° F. (5 min) respectively. The reaction chamber was filled with contaminated soil five times for each sample run to ensure a representative sample of exhaust gas was processed through the sample train. A single sample run was completed following the test runs to collect samples for total fluorine analysis. Sample gas was pulled through the sample train from the point when energy was first applied to the drum and stopped when the drum was cool enough to remove. The sample gas draw rate was maintained at 0.6 scfm for the duration of the test. The system was leak checked before and after each test run. During each test run, data was recorded every 5 minutes for the dry gas meter (DGM) inlet and outlet temperatures, delta H (flow rate), volume, filter holder temperature, and ice bath temperature. The filter holder temperature was set at 250° F.

B. Air Emissions Test Procedures and Apparatus

The emission-testing program was performed in accordance with U.S. Environmental Protection Agency Reference Methods as prescribed in Title 40 of the Code of Federal Regulations, part 60, Appendix A. The specific methods are listed below.
Method 3A—Determination of Oxygen and Carbon Dioxide Concentrations in Emissions from Stationary Sources (Instrumental Analyzer Procedure)
Method 4—Determination of Moisture content in Stack Gases
Modified Method 0010—MM-5, Method for Determining HFPO-DA and Other Method 537 PFAS

MM-5 testing consisted of three sample runs, each run including 5 sample canisters.

Prior to each sample run, the impinger train was prepared and a pre-sample impinger weight determined with a top loading electronic balance. The data was recorded on a field data sheet. The sample train was then assembled with a glass-fiber filter, the sample box heater was engaged, and the system allowed to heat up to the set-point temperature. A pre-run leak test was performed at a vacuum greater than expected during the run. A post-test leak check was performed with a vacuum greater than the maximum recorded vacuum reached during the run. Once all the leak tests had been successfully completed, the initial DGM, dry gas meter, reading was recorded. The sample flow was started when energy was applied to the canister. Data points were recorded for ΔH, sample box temperature, impinger train exit temperature, DGM inlet/outlet temperature, and system vacuum. At the end of the sample run, the sample pump valve was closed stopping sample flow. The final sample volume was recorded from the DGM. A post-run leak check was performed at a vacuum equal to or greater than the highest vacuum recorded during the run.

The impinger train was disassembled and final weights determined for each impinger (to the nearest 0.5 grams). The total grams of water captured was calculated and recorded. During PFAS testing ice water circulation through the coil condenser and the XAD traps were kept as cold as reasonably possible. The exit temperature of the coil condenser effluent (water and gases) was maintained low to prevent target analyte breakthrough. Field blanks and trip blanks were collected for analysis.

Once the system cooled, sample recovery began by disassembling the train. The probe assembly and filter assembly were sealed with polyethylene wrap and removed to a clean location for sample recovery. The sample train was disassembled. Using stainless-steel spatula and forceps, the filter was removed and labeled. Polyethylene bottles were used to transport the recovered samples to the lab. The MM-5 samples were stored and transported on ice in insulated coolers. The MM-5 sample train consisted of seven sampling fractions including the glass fiber filter, the probe/front part of the filter holder Methanol/5% NH₄OH rinses, condensate, impinger contents, the back half of the filter holder/coil condenser/connecting glassware Methanol/5% NH₄OH rinses, XAD trap, and the breakthrough XAD trap. Method 5, MM-5 equipment and associated hardware are listed below:
Test console with sample flow control, dry gas test meter, temperature controllers for probe and sample box heater, thermocouple readouts, and dual incline manometers for delta H and delta P
Leak-free vacuum pump
Thermostatically controlled heated filter box
Ice bath impinger tray with sample-out thermocouple sensor
Umbilical with Pitot lines, thermocouple wire, and control wiring
MM-5 glassware set
Filter holder for the sample box heated chamber
Pre-rinsed and weighed 47 mm glass fiber filters
XAD traps
Critical orifice sample flow calibration kit
Sample recovery kit
Analytical balance capable of determinations to 0.1 mg
   The sample train consisted of four parts:
Front half (all components upstream of and including the filter, and the sample train discharge tubing);
Back half (resin trap, condenser and connecting tubing);
Condensate (the liquid in the impinger train plus rinses); and
Break through (resin trap).

Gas samples were withdrawn at a constant rate for all test series. Gas sampling began when energy was applied to the sample canister and stopped after the canister had cooled enough to be removed. Five canisters were run for each of the three source test runs. Three runs were performed based on the canister temperature, 1200° F., 1500° F. and 1800° F. Before and after each run the bench-scale unit was disassembled and thoroughly cleaned. A significant amount of particulate matter was recovered and combined with the front half section of the sample train. The train was also rinsed with the MeOH/ammonium solution. Telaar sample bags of the exhaust gas were collected for CO₂ analysis.

C. Air Emissions Summary of Test Results

A significant amount of partial and untreated soil was captured in the front half of the exhaust gas sample train. A summary of perfluorinated chemicals (PFC) analyte hits is provided in Table 3. All hits in the treated soils were on unregulated PFC compounds.

TABLE 3
Number of analyte PFC hits from analysis of untreated and treated
soil samples and in exhaust gas collected from the treatment unit.

| | Temperature | Untreated | Treated | Exhaust Sample |
|---|---|---|---|---|
| Run | ° F. | Soil | Soil | Train |
| 1 | 1200 | 17 | 4 | 11 |
| 2 | 1500 | 17 | 4 | 11 |
| 3 | 1800 | 17 | 3 | 12 |

Moisture, air flow rate and CO₂ concentrations from each run are shown in Table 4. Based on the CO₂ concentration, it appeared that some combustion was taking place.

TABLE 4
Moisture, sample flow rate and CO₂ concentration
measurements from the emissions testing runs.

| Run | Moisture grams | Air flow rate SCFM | CO₂ % |
|---|---|---|---|
| 1 | 34 | 0.59 | .1 |
| 2 | 20 | 0.59 | .15 |
| 3 | 21 | 0.6 | .15 |

D. PFAS Accounting

The calculated mass of PFAS compounds which were present in the untreated soil, but no longer present in the treated soil, were compared to the PFAS compounds recovered in the source testing train. PFOS did not mobilize into the train without chemical transformation. In all cases, the majority of the PFAS was recovered in the front half, followed by the back half. PFAS recovered from the impinger and resin beads were negligible.

### Example 4—Design Optimization

A. Time and Temperature

It was observed that the rate of desorption of PFAS was related to both time and temperature. In general, higher temperature and treatment time resulted in lower residual PFAS concentrations. The most effective desorption was observed for particular combinations of these parameters. For example, certain test runs featured a barrel temperature of 1800° F. for a single minute. This did not allow enough time for the sample to heat all the way up to desorption temperature, despite the barrel operating at the top of its temperature range. Conversely, higher treatment times at lower temperatures were somewhat effective, but less so than higher treatment times at higher temperatures.

Furthermore, treatment time and target temperature, while attractive from a process control standpoint, were found to be imperfect parameters for description of the desorption conditions. Treatment time was measured by the amount of time the barrel was at its max temperature (as controlled by the PID) but ignored the time ramping up and down. Maximum temperature was measured at the barrel surface, and not the environment inside the chamber. The heat transfer relationship between these parameters and the conditions inside the barrel could be understood for the bench system but are unlikely to scale predictably.

It was therefore decided to draw relationships between the residual PFAS concentration and the heat environment inside the chamber itself. The metric “degree-minutes above 500° F.” was selected because it represents both time and temperature in a single variable and starts at a point generally close to where relevant PFAS compounds start to volatilize. It was therefore identified as a design variable for commercial scale systems, and can be used as an optimization variable. It can be calculated by integrating the time/temperature curve of the measured environment inside the barrel, with a lower limit of 500° F. It is represented by the shaded area on the graph shown in FIG. 43.

B. Starting Concentration

Desorption rate is a function of time and concentration. It was observed that heavily concentrated samples (such as the spiked samples) required higher temperatures and treatment times. It is anticipated that highly concentrated sites can be dealt with above 10,000 degree-minutes above 500° F. This can be accomplished by a combination of higher treatment temperatures and higher retention time.

### Example 5. Compound-Specific Behavior

A. PFOS

PFOS, arguably the most well-known and widely regulated PFAS substance, was abundant in the contaminated soil treated during this work. It was found to present very few challenges for desorption and combustion.

At very low temperatures (450-500° F.), PFOS remained in place while other compounds had started to desorb or undergo chemical reactions. However, once desorption temperatures were reaches, PFOS desorbed quickly and completely.

By 2000 degree-minutes, no appreciable PFOS was recovered on any run.

PFOS was not recovered in the source testing train in any appreciable amounts. This suggests that PFOS was in fact denatured or destroyed at desorption temperatures.

B. PFOA

In general, the PFOA concentration approached zero after 2600 degree-minutes.

C. PFHXS

PFHXS was present at multiple sites in the 3-7 μg/kg range. It took 5000 degree-minutes to reliably desorb all the PFHXS in the samples, which dictated the total degree-minute target for the samples.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art, and having the benefit of this disclosure, that changes may be made to the details of the above-described embodiments without departing from the underlying principles of the disclosure herein.

1. A remediation process, the process comprising:
receiving a feed stream comprising a per- and polyfluoroalkyl substance (PFAS) compound-contaminated material;
introducing the material into a vessel; and
heating the material in the vessel for at least 2000 degree F.*minutes above 500° F. to reduce the PFAS compound present in the material below a selected level, wherein degree F.*minutes above 500° F. is a measure of the area under the curve of a plot of the temperature of the material above 500° F. and the time of the material in the vessel at temperatures above 500° F.

2. The process of claim 1, further comprising heating the vessel to at least 1200° F.

3. The process of claim 1, further comprising, prior to the heating step, determining a minimum degree F.*minutes above 500° F. needed to reduce the PFAS compound present in the material below a selected level.

4. The process of claim 1, wherein determining the minimum degree F.*minutes above 500° F. needed to reduce the PFAS compound present in the material below the selected level comprises determining specific PFAS compounds, chemical types, or both present in the material and their concentration and utilizing a lookup table to determine the minimum degree F.*minutes above 500° F. needed for the specific PFAS compounds.

5. The process of claim 1, wherein determining the minimum degree F.*minutes above 500° F. needed to reduce the PFAS compound present in the material below the selected level comprises performing a bench test on a sample of the material.

6. The process of claim 1, wherein maintaining the material in the vessel for at least 2000 degree F.*minutes above 500° F. comprises maintaining the material in the vessel for at least 4 minutes with the temperature of the material at 1000° F. or higher.

7. The process of claim 1, wherein maintaining the material in the vessel for at least 2000 degree F.*minutes above 500° F. comprises maintaining the material in the vessel for at least 2500 degree F.*minutes above 500° F., at least 3000 degree F.*minutes above 500° F., at least 3500 degree F.*minutes above 500° F., at least 4000 degree F.*minutes above 500° F., at least 4500 degree F.*minutes above 500° F., or at least 5000 degree F.*minutes above 500° F.

8. The process of claim 1, wherein heating the vessel comprises uniformly circumferentially heating the vessel.

9. The process of claim 1, further comprising mixing the material within the vessel while maintaining close contact between the material and an interior surface of the vessel.

10. The process of claim 1, wherein heating the vessel comprises inductively heating the vessel.

11. The process of claim 1, wherein the material exiting the vessel has less than 1 microgram of PFAS compound per kilogram of material.

12. The process of claim 1, wherein the PFAS compound concentration in the material exiting the vessel has been reduced by at least 95%, at least 10 fold, at least 100 fold, or at least 1000 fold.

13. The process of claim 1, wherein the degree F.*minutes above 500° F. comprises a sum of average temperatures of the material above 500° F. for each minute the material is above 500° F.

14. The process of claim 1, further comprising separating vapors containing PFAS or partially-decomposed PFAS hydrocarbons from the material into an impure vapor stream and producing a purified solids stream.

15. The process of claim 1, further comprising operating the vessel at a negative pressure while heating the material.

16. The process of claim 1, further comprising preheating the material contaminated with PFAS sufficient to volatilize at least a portion of moisture in the material prior to introducing the material into the vessel.

17. The process of claim 1, further comprising mixing one or more additive streams, one or more liquid or solid streams from other parts of the process, or combinations thereof with the PFAS-contaminated material in the feed stream, prior to introducing the material into the vessel.

18. The process of claim 1, further comprising determining a chemical type of the PFAS in the material.

19. The process of claim 1, further comprising modifying a pH, moisture content, or both of the feed stream based on a chemical type of the PFAS in the material.

20. A system for removing per- and polyfluoroalkyl substance (PFAS) compounds, the system comprising:
a vessel configured to receive a feed stream containing PFAS-contaminated material, the vessel comprising a rotatable barrel having a receiving end, a discharging end, an interior surface, and an exterior surface,
the rotatable barrel operably coupled to a heater configured to indirectly, circumferentially heat the rotatable barrel to at least 1350° F., and
the rotatable barrel configured to maintain the material in the interior of the rotatable barrel for a sufficient period of time to reduce a concentration of the PFAS in the material below a selected level.
